(19) United States
(12) Patent Application Publication
(10) Pub. No.: US 2014/0129326 A1
(43) Pub. Date: May 8, 2014

(54) METHOD AND APPARATUS FOR ADVERTISING USING SOCIAL MEDIA

(71) Applicant: Gary Paul Munitz, Maroubra (AU)

(72) Inventor: Gary Paul Munitz, Maroubra (AU)

(21) Appl. No.: 14/003,233

(22) PCT Filed: Mar. 2, 2012
(86) PCT No.: PCT/AU2012/000213

§ 371 Date: Jan. 16, 2014

(30) Foreign Application Priority Data
Mar. 4, 2011 (AU) 2011900772

(51) Int. Cl. G06Q 30/02; G06Q 50/00

(52) U.S. Cl. CPC G06Q 30/0269; G06Q 30/0249; G06Q 50/01
USPC 705/14.48; 705/14.66

(57) ABSTRACT

A method and apparatus for advertising over a computer network using social media. The method comprising the steps of: presenting a campaign interface to a campaign entity for initiating a campaign; receiving media data indicative of one or more selected social media avenues associated with the campaign; receiving message data indicative of one or more messages to be associated with each of the selected social media avenues; receiving, for each selected social media avenue, targeting data indicative of a respective campaign budget and campaign parameters; initiating the campaign; receiving payment from the campaign entity; presenting a socialite interface to a first socialite entity for enabling selection from available campaigns; receiving campaign selection data indicative of at least a first campaign selected; presenting available media avenues associated with the first campaign selected; receiving media selection data indicative of a first media avenue selected from the one or more social media avenues associated with the first campaign selected; presenting the one or more messages associated with the first media avenue selected; receiving message selection data indicative of a first message selected from the one or more messages associated with the first media avenue selected; and posting the first message selected, as a campaign posting on behalf of the first socialite entity, to the first social media avenue selected.

### CROSS-REFERENCE TO RELATED APPLICATIONS

This application is a National Phase application of PCT International Application No. PCT/AU2012/000213, filed Mar. 2, 2013, which claims priority to Australian Application No. AU 2011900772, filed Mar. 4, 2011, each of which is incorporated herein by reference in its entirety.

### FIELD OF THE INVENTION

The present invention relates to advertising and in particular to advertising for electronic media.

The invention has been developed primarily for use as a method and apparatus for advertising for social media and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known methods of advertising on social media (systems or sites) is facilitated by the social media provider, whereby advertising is typically presented without direct involvement from a member. For example, a social media provider can enable an advertising panel for Google AdWords viewable to each member.

It would be appreciated that advertising is selected based on parameters derived from the member account, and presented to that member. However, the advertisement may no longer relevant to that member. It would be appreciated that this advertising is not presented with any member relevant endorsement.

There is a need in the art or advertising on social media to engage or involve the member.

### OBJECT OF THE INVENTION

It is an object of the present invention to overcome or ameliorate at least one of the disadvantages of the prior art, or to provide a useful alternative.

It is an object of the invention in its preferred form to provide a method of, or apparatus, for advertising using social media.

### SUMMARY

According to an aspect of the invention there is provided a method for advertising using social media, the method comprising the steps of:

(a) Presenting a campaign interface to a campaign entity for initiating a campaign;

(b) Receiving media data indicative of one or more selected social media avenues associated with the campaign;

(c) Receiving message data indicative of one or more messages to be associated with each of the selected social media avenues;

(d) Receiving, for each selected social media avenue, targeting data indicative of a respective campaign budget and campaign parameters;

(e) Initiating the campaign;

(f) Receiving payment from the campaign entity;

(g) Presenting a socialite interface to a first socialite entity for enabling selection from available campaigns;

(h) Receiving campaign selection data indicative of at least a first campaign selected;

(i) Presenting available media avenues associated with the first campaign selected;

(j) Receiving media selection data indicative of a first media avenue selected from the one or more social media avenues associated with the first campaign selected;

(k) Presenting the one or more messages associated with the first media avenue selected;

(l) Receiving message selection data indicative of a first message selected from the one or more messages associated with the first media avenue selected; and

(m) Posting the first message selected, as a campaign posting on behalf of the first socialite entity, to the first social media avenue selected.

Preferably, the method for advertising using social media can further comprise the steps of:

(n) Validating the campaign posting; and

(o) Facilitating payment made to a socialite entity for a validated campaign posting.

Preferably, steps (i) through (m) are repeated for each of the one or more social media avenues associated with the first campaign. More preferably, the first socialite can repeat steps (i) through (m) for enabling the first socialite to indicate a second (or more) campaign selection.

Preferably, a second socialite entity can undertake method steps (g) through (m).

Preferably, initiating a campaign involves a transfer of funds to an advertising entity.

Preferably, a campaign budget specifies available payment terms for a prospective socialite entity. More preferably, a campaign budget can specify any one or more of: Cost Per Friend/Follower (or Connection etc, and social grouping) (CPF), Cost Per Click (CPC) or Cost Per Acquisition (CPA).

Preferably, campaign parameters can include restrictions imposed, by the campaign entity, on availability of a campaign to a socialite entity. More preferably, campaign parameters can include any one or more of: maximum allowable overlap, minimum allowable number of friends or followers, maximum allowable number of friends or followers, allowable geographic region, allowable age brackets, allowable languages, allowable date and time to post or publish, allowable date range for campaign, and category (for example retail, lifestyle etc). Most preferably, a socialite entity is presented with only available campaigns.

According to an aspect of the invention there is provided a method of initiating a campaign for advertising using social media, the method comprising the steps of:

(i) Presenting a campaign interface to a campaign entity for initiating a campaign;

(ii) Receiving media data indicative of one or more selected social media avenues associated with the campaign;

(iii) Receiving message data indicative of one or more messages to be associated with each of the selected social media avenues;

(iv) Receiving, for each selected social media avenue, targeting data indicative of a respective campaign budget and campaign parameters; and

(v) Initiating the campaign.

Preferably, payment is received by the advertising entity from the campaign entity. More preferably, this payment is held until completion of the campaign. Most preferably, this payment is made at the time the campaign is initiated.

Preferably, an initiated campaign can be posted or published to social media using a method of posting a campaign for advertising using social media—as herein described.

According to an aspect of the invention there is provided a method of posting a campaign message for advertising using social media, the method comprising the steps of:

(i) Presenting a socialite interface to a first socialite entity for enabling selection from available campaigns;

(ii) Receiving campaign selection data indicative of at least a first campaign selected;

(iii) Presenting available media avenues associated with the first campaign selected;

(iv) Receiving media selection data indicative of a first media avenue selected from the one or more social media avenues associated with the first campaign selected;

(v) Presenting the one or more messages associated with the first media avenue selected;

(vi) Receiving message selection data indicative of a first message selected from the one or more messages associated with the first media avenue selected; and

(vii) Posting the first message selected, as a campaign posting on behalf of the first socialite entity, to the first social media avenue selected.

Preferably, the campaign is initiated according to a method of initiating a campaign for advertising using social media—as herein described.

Preferably, the campaign posting is validated. More preferably, payment can be made to the first socialite entity for a validated campaign posting.

According to an aspect of the invention there is provided an apparatus for advertising using social media, the apparatus comprising:

A processor element coupleable to a database, the database being adapted to retain campaign data;

The processor element being adapted to present a campaign interface to a campaign entity for receiving campaign data and to initiate the campaign;

The processor element being adapted to present a socialite interface to a socialite entity for enabling campaign selection;

The processor element being adapted to post one or more campaign messages, on behalf of the socialite, to a social media avenue.

Preferably, campaign data includes any one or more selected from the set comprising: media data, message data, and targeting data.

Preferably, the database further includes a socialite record comprising data indicative of the socialite entity. More preferably, the socialite record includes data indicative of socialite campaign selection and socialite performance history.

Preferably, the campaign interface or socialite interface is presented through a data communication network. More preferably, an interface is presented through a web interface.

According to an aspect of the invention there is provided a campaign interface for a processor device, the processor device being operatively associated with advertising using social media, the processor device being coupleable to database for retaining campaign data; the interface comprising: a control program adapted to perform a method of initiating a campaign for advertising using social media as herein described.

According to an aspect of the invention there is provided a socialite interface for a processor device, the processor device being adapted to provide advertising using social media, the processor device being coupleable to database having campaign data; the interface comprising: a control program adapted to perform a method of posting campaign for advertising using social media as herein described.

According to a further aspect of the invention there is provided a computer program product stored on a computer usable medium, the computer program product adapted to provide a method of initiating a campaign for advertising using social media as herein described.

According to a further aspect of the invention there is provided a computer program product stored on a computer usable medium, the computer program product adapted to provide a method of posting a campaign message for advertising using social media as herein described.

Preferably the computer program is provided on a computer readable medium for operation with a processor device, the computer readable medium comprising computer code for executing the respective method.

### BRIEF DESCRIPTION OF THE DRAWINGS

A preferred embodiment of the invention will now be described, by way of example only, with reference to the accompanying drawings in which:

FIG. 1 is a schematic view of an embodiment apparatus according to the invention;

FIG. 2 is a flowchart of an embodiment method according to the invention;

FIG. 3 is a flowchart of an embodiment method according to the invention, showing steps for initiating a campaign for advertising using social media;

FIG. 4 is a schematic view of an embodiment campaign interface according to the invention;

FIG. 5 is a flowchart of an embodiment method according to the invention, showing steps for posting a campaign message for advertising using social media;

FIG. 6a is a schematic view of an embodiment socialite interface according to the invention;

FIG. 6b is a schematic view of an embodiment socialite interface according to the invention; and

FIG. 7 is a schematic view of an embodiment social media, shown presenting a campaign message.

### PREFERRED EMBODIMENT OF THE INVENTION

In an embodiment, a campaign entities (or advertiser) can create campaigns comprising of a variety of advertisements across one or more social media avenues (or channels). The advertisements can be allocated a budget and targeting criteria. Campaign entities link funds to their campaigns securely via a finds transfer using a credit card (or other forms of secure payment).

In an embodiment, a socialite entity can be selectively shown relevant campaigns (based on the campaign entities targeting criteria), and then select which campaigns they consider reflects them or that their endorsement would encourage their associated friends or followers to accept or embrace the campaign, such that the campaign message is adequately distributed in the social media for the campaign entity.

In an embodiment apparatus, the advertising entity can facilitate charging of a fee to a campaign entity, and to facilitate payment to a socialite entity on the agreed timeframe—less an agreed commission.

As a Socialite uses the apparatus, the apparatus or system can learns about the socialite and their associated followers/friends, and improves how the socialite is matched to campaigns based on a wide range of criteria. Also, the socialite can improve their ranking if they engage more with the system, and can be offered higher fees and better quality campaigns.

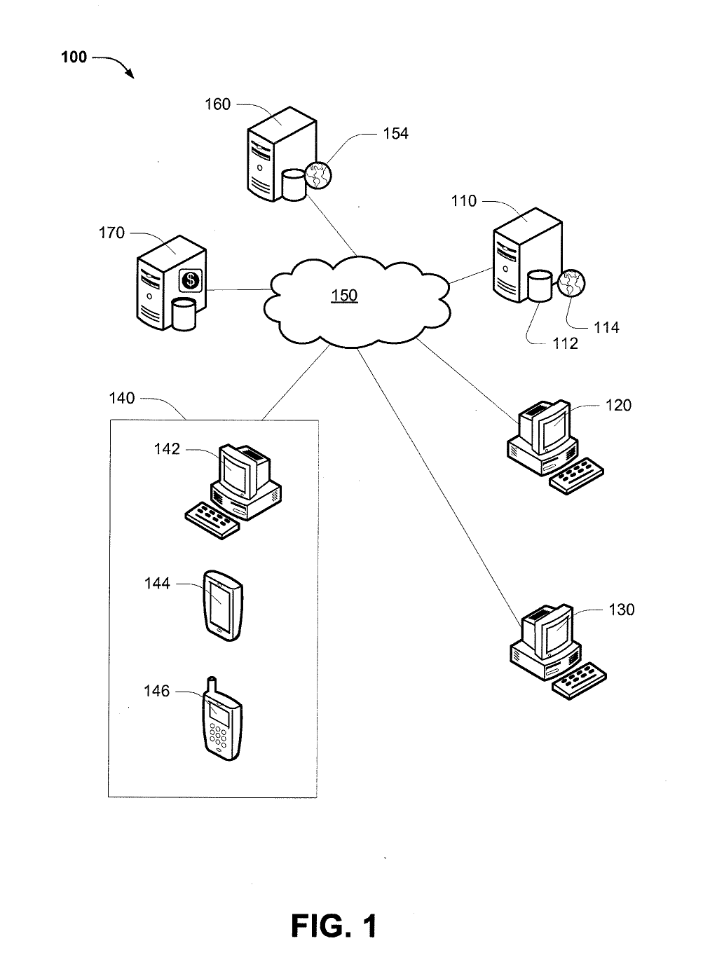

FIG. 1 shows an embodiment apparatus 100 for advertising using social media. This apparatus comprises:

a processor element 110 coupleable to a database 112, the database including campaign data;

The processor element being adapted to present a campaign interface on a campaign interface element 120 to a campaign entity for receiving campaign data;

The processor element being adapted to present a socialite interface on a socialite interface element 130 to a socialite entity for enabling campaign selection;

The processor element being adapted to post one or more campaign messages, on behalf of the socialite, to a social media.

The campaign message being viewable on the social media via a member interface element 140. For example, the campaign message being viewable on the social media via a member element including a personal computer or laptop 142, personal digital assistant 144, or mobile phone 146.

In this embodiment, the processor element can use a web server 114 to present the campaign interface and/or the socialite interface via a web interface.

It will be appreciated that an interface element (120, 130, 140) can, by way of example include any one or more of the following: a mobile phone, a cell phone, smart phone, laptop, netbook, personal computer, personal digital assistant or other electronic interface devices. A software application can be provided for facilitating presentation of the respective interface or social media.

In this embodiment, each interface device can be coupled to the processor element 110 by a data network 150. A member to a social media can view their profile that displays a campaign message submitted on behalf of another member (the socialite entity).

A member (or user) typically accesses the social media interface in the form of a web interface presented by a social media server 160 (or web server 162).

One or more financial element 170 can be coupled to processor element to facilitate funds transfer.

from the campaign entity to the market entity;

from the market entity to the socialite entity; and/or

from the campaign entity to the socialite entity.

In an example embodiment, an interface can be tailored for mobile or handheld devices, for example using style sheets. Alternatively, an interface can be a custom interface presented by the respective interface element.

It will also be appreciated that software applications can be provided for presenting (or displaying) an interface, whereby the applications can make requests to the processor element 110 via an interface module 114 or alternatively directly access the database 114. A socialite entity or campaign entity can be authenticated prior to accessing a respective interface.

In using the apparatus shown in FIG. 1, advertising can be presented using social media.

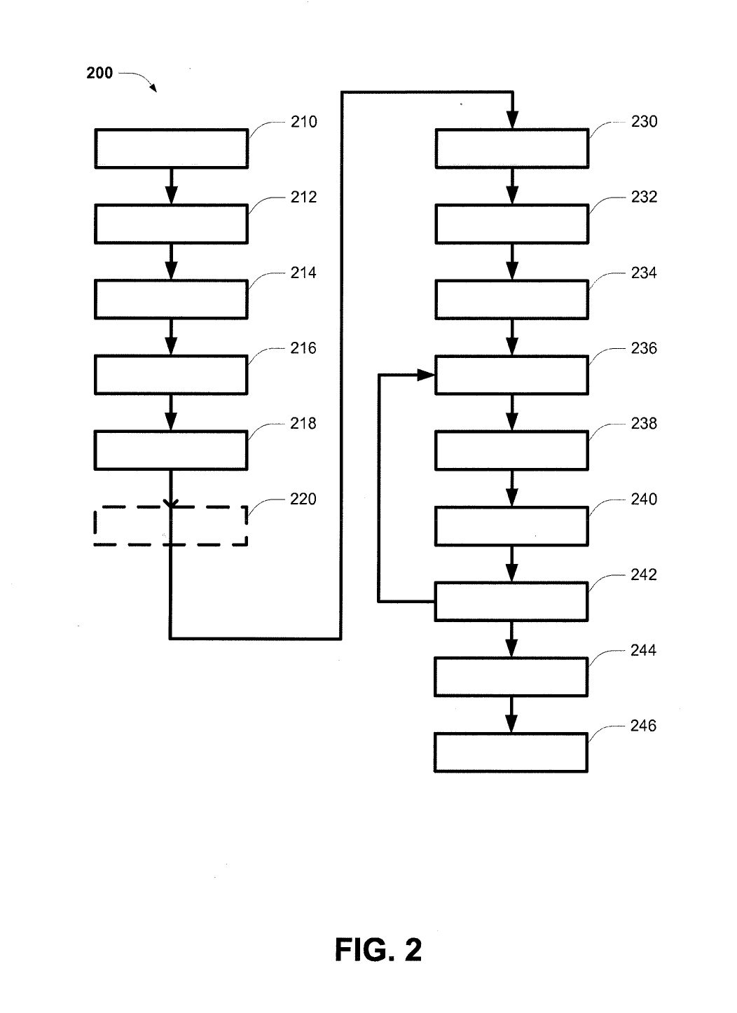

FIG. 2 shows an embodiment method 200 of advertising using social media. This method comprising the steps of:
STEP 210: presenting a campaign interface to a campaign entity for initiating a campaign;
STEP 212: receiving media data indicative of one or more selected social media avenues associated with the campaign;
STEP 214: receiving message data indicative of one or more messages to be associated with each of the selected social media avenues;
STEP 216: receiving, for each selected social media avenue, targeting data indicative of a respective campaign budget and campaign parameters;
STEP 218: initiating the campaign;
STEP 220: receiving payment from the campaign entity;
STEP 230: presenting a socialite interface to a first socialite entity for enabling selection from available campaigns;
STEP 232: receiving campaign selection data indicative of at least a first campaign selected;
STEP 234: presenting available media avenues associated with the first campaign selected;
STEP 236: receiving media selection data indicative of a first media avenue selected from the one or more social media avenues associated with the first campaign selected;
STEP 238: presenting the one or more messages associated with the first media avenue selected;
STEP 240: receiving message selection data indicative of a first message selected from the one or more messages associated with the first media avenue selected; and
STEP 242: posting the first message selected, as a campaign posting on behalf of the first socialite entity, to the first social media avenue selected.

By repeating STEP 234 through STEP 242, for each of the one or more social media avenues associated with the first campaign, a campaign message can be posted on behalf of the socialite to each selected media avenue.

It will be appreciated that the first socialite can: repeat steps STEP 234 through STEP 242 for enabling the first socialite to indicate a second (or more) media selection; and/or repeat STEP 230 through STEP 242 for enabling the first socialite to indicate a second (or more) campaign selection.

The method 200 can further comprise the steps of:
STEP 244: validating the campaign posting; and
STEP 246: facilitating payment made to a socialite entity for a validated campaign posting.

It will be appreciated that one or more social entities can undertake method STEP 230 through STEP 242 (and/or through to STEP 246).

### Campaign Entity

Campaign entities (or advertiser) can sign up or register to create campaigns.

In an embodiment, a campaign entity can set campaign parameters that enable any one or more of the following:
setting budgets per social media avenue—wherein, by way of example only, budgets are based on CPF (such as Ic per 5 friends with a max of 50% overlap) and/or CPC (such as 50 c per click) and/or CPA (such as $5 per sale or 5% per sale)—and wherein Budgets can be configured for each of the one or more Social Media avenues;
enabling the campaign entity to configure a separate budget for each respective social media avenue;
defining targeting parameters (or criteria)—wherein, by way of example only, the target parameters can be based on any one or more selected from the set including: geographic regions, age brackets, languages, min/max number of friends, category (such as retail, lifestyle etc), date and time to publish and date range to run;
enabling the Campaign Entity to configure targeting parameters to enable a budget to correspond to a specific date/time range;
define tag or meta data to assist a socialite entity to identify a relevant campaign, therein the tag data can be provided, by way of example, by manual entry of terms or a selection from a pick-list of terms;
define a campaign/advertisement across a plurality of social media avenues, for example Facebook, Twitter, LinkedIn, Hi5;
a plurality of creative messages associated with each advertisement and each social media avenue;
URL (web address) of the campaign entity choosing;
media other than text data (for example, images and/or video;
campaign entity identifies a payment method, for example secure credit card, Paypal, and/or direct transfer.

In an embodiment, campaign tracking may also be incorporated into a campaign. By way of example, a tracking means may include:
prior to posting a message selected by a socialite entity, each included web links can be converted (preferably automatically) to a respective URL that is directed to a tracking entity, whereby web traffic can be tracked and/or counted for a cost per click (CPC) tracking module, before automatically re-directing the viewer to the campaign URL specified by the campaign entity;
a tracking pixel can be made available to campaign entities for inclusion on a campaign web page, which enables a cost per acquisition (CPA) tracking model for reporting a respective sale to a tracking entity—as well as a number of other relevant facts used to calculate costs for a campaign, including: an order reference to referencing back to a specific purchase, a total order value which can be used to then calculate the amount owing, a campaign entity identification data, a respective profit margin for better reporting.

In an embodiment, campaign entity reporting is provided. For example, detailed reports can be provided to each campaign entity for clearly establishing a campaign cost. These report can include: the number of socialite entities that have published their campaign, the social media avenues to which the campaign have been published, the number socialites (friends/followers) that have been exposed to a campaign; the number of unique socialites exposed to a campaign; the number of click through traffic (where available); the reported sales derived from a campaign, the total dollar value of those the reported sales (for example per sale); campaign entity margins (where available), total profit from those transactions (where available).

In an embodiment, a campaign entity provides payment in respect of each initiated campaign. Depending on the credit rating of a respective campaign entity, payment may be required prior to initiating (or launching) a campaign. A campaign entity can establish an account, and be notified when available funds are low. The spend rate associated with a campaign may be estimated for identifying a reasonable notice period for sending notifications to a campaign entity to top up an account. The campaign entity can, upon notification, login to the advertising entity and manually top up funds Alternatively, a campaign entity can request to be automatically debited, from their chosen payment method, when available funds drop below a threshold—thereby ensuring their campaign continues uninterrupted.

The advertising entity may automatically suspend a campaign if funds are not available. Alternatively, the campaign entity may allow a campaign entity to operate using a line of limited credit depending on the Credit Rating of the campaign entity.

The advertising entity can support a plurality of payment methods, including pre-payment and post-payment (subject to a campaign entity credit rating).

It will be appreciated that an advertising entity can receive payment for any one or more of the following: initiating a campaign; posting a message; cost per click; or cost per acquisition. This payment may include one or more of: a one off campaign payment, a percentage of the socialite payment for a verified posted message.

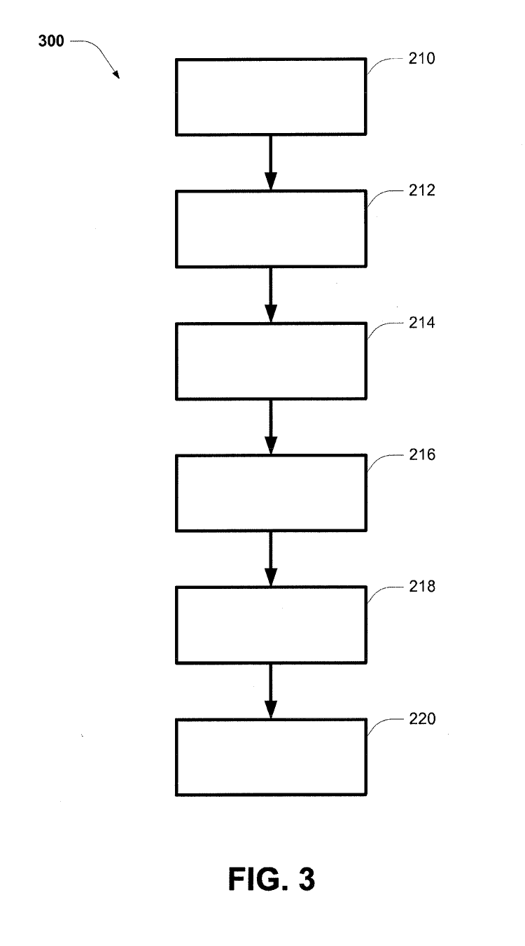

FIG. 3 shows, by way of example, flowchart 300 for a method of initiating a campaign for advertising using social media. The method comprising the steps of:
STEP 210: presenting a campaign interface to a campaign entity for initiating a campaign;
STEP 212: receiving media data indicative of one or more selected social media avenues associated with the campaign;
STEP 214: receiving message data indicative of one or more messages to be associated with each of the selected social media avenues;
STEP 216: receiving, for each selected social media avenue, targeting data indicative of a respective campaign budget and campaign parameters; and
STEP 218: initiating the campaign.

In an embodiment, the methods can include STEP 220 for receiving payment funds, by the advertising entity, from the campaign entity. This payment funds can typically be made at, or about, the time the campaign is initiated and can be held until completion of the campaign.

It will be appreciated that an initiated campaign can be posted or published to social media using a method of posting a campaign for advertising using social media—as herein described.

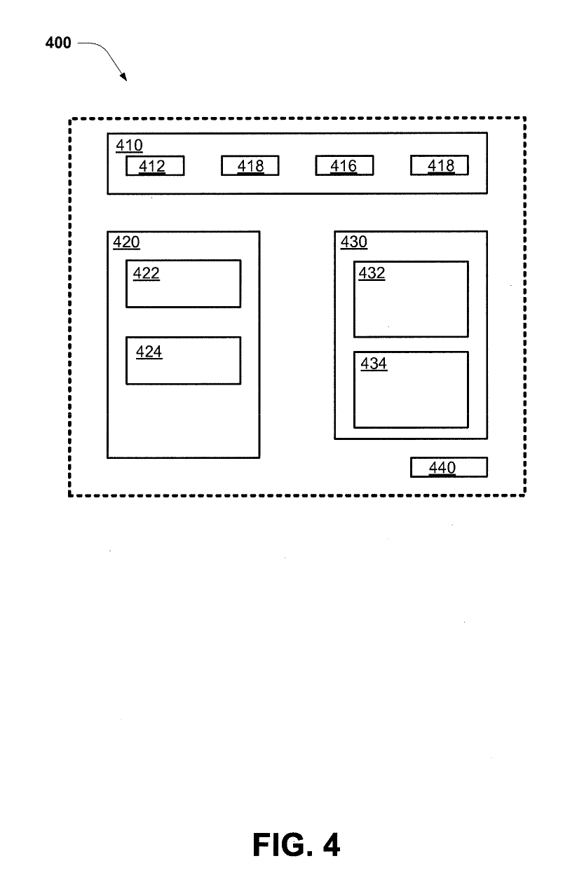

FIG. 4 shows, by way of example, a schematic view of an embodiment campaign interface 400. This campaign interface can include:
one or more campaign social media avenue selection elements 410, for example Facebook 412, Twitter 414, LinkedIn 416, and Hi5 418;
one or more campaign media data elements 420, each associated with at least on of the one or more campaign social media avenue selection elements of the campaign;
a targeting data element 430 for receiving data indicative of a respective campaign budget 432 and campaign parameters 434; and
an initiation element 440 for finalizing initiating the campaign.

Typically, each of the one or more campaign media data elements 420, for example 422 and 424, can comprise alternative messages selectable by a socialite entity, in respect of a campaign and social media avenue.

### Socialite Entity

A Socialite entity can, by way of example, interact with an advertising entity in any one or more of the following:
logging onto a advertising entity, typically using existing login details from their chosen social media avenue, or existing login details for an advertising account with the advertising entity;
linking one or more socialite entities respective associate social media avenue accounts within a socialite record maintained by the advertising entity, which presents relevant campaigns (such as campaigns assigned associated social media avenues);
maintaining a socialite record for retaining a socialite entity activity data;
presenting a socialite entity with relevant campaigns, through one of a plurality of available views (such as, by category, by campaign entity, by payment amount, by relevance to socialite followers or friends),
presenting a socialite with a search facility/mechanism that searches through targeting data, campaign tag data, campaign budget and campaign parameters;
presenting a socialite entity with relevant information about each suitable campaign, including: associated marketing messages, associated advertising method (CPF, CPC, CPA), and verification timeframe;
a socialite entity being enabled to select a relevant campaigns, at their discretion that they feel suit their followers/friend base and elect to publish a respective message on behalf of the socialite entity;
a marketing message being published on the related social media avenue, typically on behalf of the socialite entity;
if a selected/published campaign is assigned a payment method being cost per friend (CPF), at publication a payment fee is allocated to the socialite entity—being debited from a campaign entity account allocated to the campaign;
presenting pending payments to the socialite entity.
If a selected/published campaign is assigned a payment method being cost per click (CPC), a payment fee is allocated to the socialite entity upon each tracked web access initiated by a socialite member;
If a selected/published campaign is assigned a payment method being cost per click (CPC), a payment fee is allocated to the socialite entity upon each tracked access by a socialite member,
If a selected/published campaign is assigned a payment method being cost per acquisition (CPA), a payment fee is allocated to the socialite entity upon each tracked acquisition/purchase by a socialite member;

In an embodiment, a payment can be provided to a socialite entity. Upon completion of a verification period, the message post can be verified to confirm appropriate maintenance of the message by the socialite entity, and a respective fee amount can be transferred from a pending-payment status to ready-for-payment status. On an agreed Payment Cycle, a socialite entity can receive a fund transfer (via a predetermined socialite method of payment). It will be appreciated that other terms of payment may be required, such as a minimum payment threshold. Alternatively, the fund transfer can be made in a subsequent payment cycle—when the minimum payment threshold has been satisfied.

In an embodiment, for cost per click (CPC) or cost per acquisition (CPA) payment methods, a verification timeframe can be set by either the campaign entity or advertising entity.

In an embodiment, for a cost per friend (CPF) payment method, the campaign entity can specify a verification timeframe for providing an appropriate value for money. Alternatively, the advertising entity can set a minimum verification timeframe.

In an embodiment, socialite entity reporting is provided. For example, detailed reports can be provided to each socialite entity on a periodic basis or upon request. A socialite report can identify campaigns posted by the respective socialite entity, including which marketing messages from which campaigns were published to which social media avenue. The socialite report can further include: the number of friends/followers that were linked/associated with their account at the time the marketing message was posted/published; the number of friends/followers that click though the posted message (when applicable); and the number of acquisitions/sales attributed to friends/followers in respect of the posted message (when applicable). The socialite report can further include: payment details showing: how much fees amount in their pending-payments, ready-for-payment and past payments.

A socialite record can, by way of example, maintain data associated with a socialite entity. For example, a socialite entity can specify a preferred method of payment; view and modify advertising entity member information, typically initially provided when becoming a member.

A socialite record can, by way of example, retain data associated with a socialite entity, including data indicative of any one or more of the following: country of residence, state of residence, city of residence, suburb of residence, age (or date of birth), languages used in social media avenues, gender. This data can enable an advertising entity to better identify relevant campaigns.

It will also be appreciated that a socialite entity may manage notification settings. For example the notification setting, retained in a socialite record, can specify how often and where recommendations of suitable campaigns are transmitted to a socialite entity for consideration. A notifications can be periodically sent to socialite entities, and include recommended campaign messages. This enables the socialite entity to follow direction in the message to in effect create a one click publishing mechanism. Notifications can further present information as if the respective socialite entity had browsed to the campaign themselves, for providing the socialite entity with information suitable to make an instant decision to publish any or all recommended campaign messages.

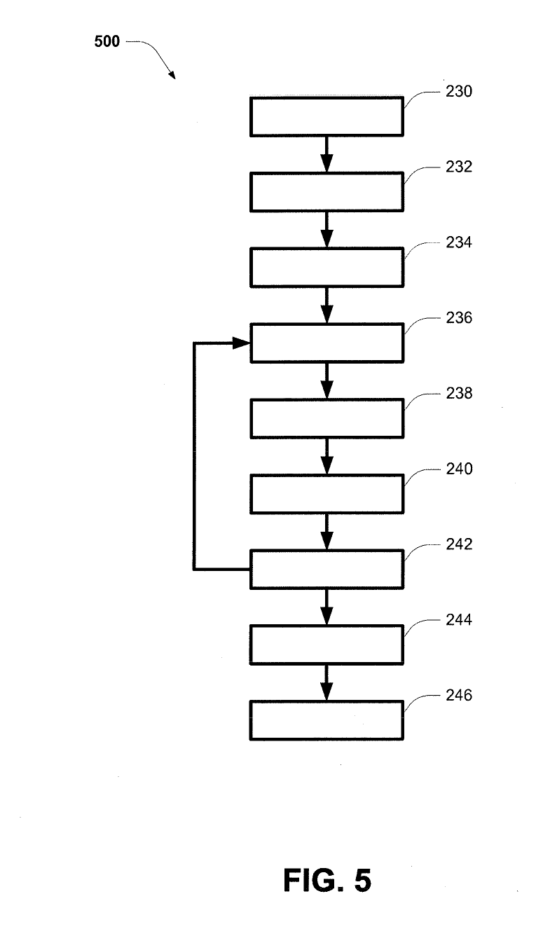

FIG. 5 shows, by way of example, flowchart 500 for a method of posting a campaign message for advertising using social media. The method comprising the steps of:
STEP 230: presenting a socialite interface to a first socialite entity for enabling selection from available campaigns;
STEP 232: receiving campaign selection data indicative of at least a first campaign selected;
STEP 234: presenting available media avenues associated with the first campaign selected;
STEP 236: receiving media selection data indicative of a first media avenue selected from the one or more social media avenues associated with the first campaign selected;
STEP 238: presenting the one or more messages associated with the first media avenue selected;
STEP 240: receiving message selection data indicative of a first message selected from the one or more messages associated with the first media avenue selected; and
STEP 242: posting the first message selected, as a campaign posting on behalf of the first socialite entity, to the first social media avenue selected.

By repeating STEP 234 through STEP 242, for each of the one or more social media avenues associated with the first campaign, a campaign message can be posted on behalf of the socialite to each selected media avenue.

It will be appreciated that the first socialite can: repeat steps STEP 234 through STEP 242 for enabling the first socialite to indicate a second (or more) media selection; and/or repeat STEP 230 through STEP 242 for enabling the first socialite to indicate a second (or more) campaign selection.

The advertising entity can, by way of example, restrict available campaigns presented to a socialite entity using predetermined criteria. This criteria can include, limiting the socialite to engage in only a set number of campaigns in a given time period, or limit campaigns to a predetermined range of available payment.

The method 200 can further comprise the steps of:
STEP 244: validating the campaign posting; and
STEP 246: facilitating payment made to a socialite entity for a validated campaign posting.

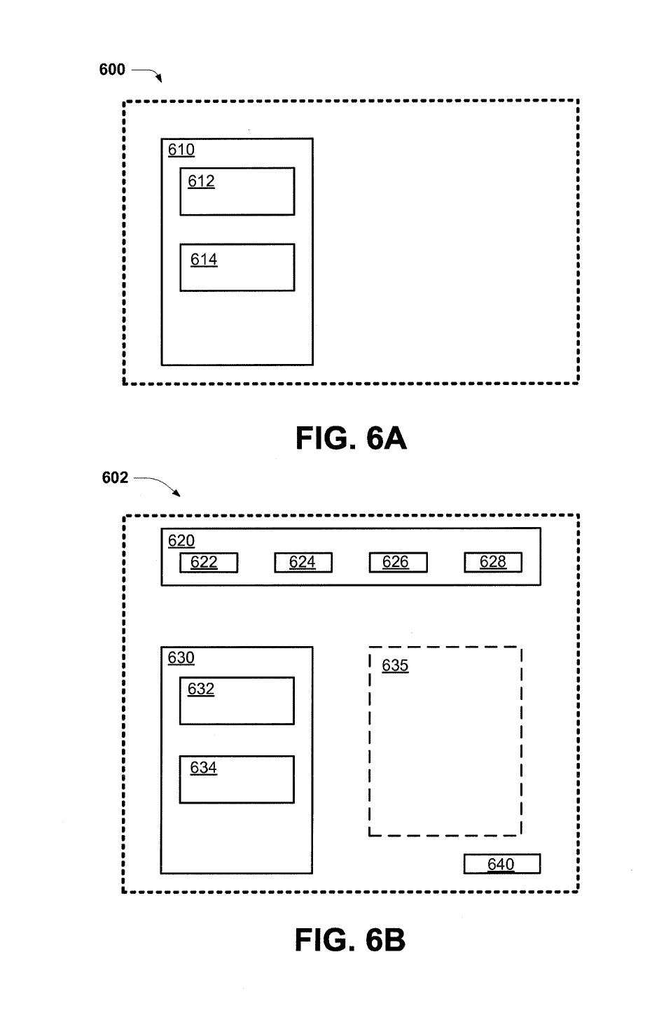

FIG. 6A and FIG. 6B shows, by way of example, a schematic view of an embodiment socialite interface 600, 602.

Referring to FIG. 6A, the socialite interface 600 can include a campaign option element 610, including one or more appropriate/suitable campaign options 612 and 614. Appropriate/suitable campaign options can be selected in respect of a socialite (or socialite record). Details/information relevant to each campaign may be presented. By selecting a campaign, the socialite entity may further provide media avenue selection and message selection.

Referring to FIG. 6B, the socialite interface 602 can enable a socialite entity to provide media avenue selection and message selection. This interface, can include
one or more social media avenue selection elements 620, for example Facebook 622, Twitter 624, LinkedIn 626, and Hi5 628;
one or more campaign media data elements 630, each associated with at least on of the one or more campaign social media avenue selection elements of the campaign; and
an initiation element 640 for finalizing initiating the campaign.

It will be appreciated that the socialite entity is responsible for selecting appropriate campaigns and messages that would be suitable for their followers/friends. Therefore the success of the campaign can be, at least partially, associated with the socialite entity selected social media avenue and message.

By way of example, a socialite entity may be rewarded for obtaining positive outcomes as measured by the performance criteria. Repeated good performance may attract a benefit, including any one or more of the following: a bonus payment; an increased rate of payment for campaigns (such as a % premium); or a preferential access to advertising campaigns. A socialite may also be penalised for obtaining poor outcomes as measured by the performance criteria, may attract a benefit, including any one or more of the following: restrictions to campaigns; or a lower payment for campaigns (% reduction in payable rates.

For a broadcast posting, all friends of followers (having socialite enabled access) can view the post via the social media avenue—for example Twitter posts or Facebook wall posts.

A socialite may alternatively directly (or privately) post a campaign to all, or a selected subset of, followers/friends by sending a message using available contact details. In an embodiment, contact records associated with a socialite entity social media avenue account provides direct or private contact access to followers/friends. By assessing the contact records a campaign post can be directly sent to each selected followers/friends. For campaign tracking a campaign posts can be further customised to: uniquely identify each campaign post to each followers/friends, or to uniquely identify each campaign post. The socialite interface 602 can include a selection element 635 for selecting all, or a selected subset of, followers/friends.

By way of example, a socialite entity being a member of an email social media avenue, for example Google Mail, HotMail, or Yahoo Mail, can enable an advertising entity to retrieve contact details of friends/followers and directly send each (or each of a selected subset) a campaign post. A social media avenue, being any online community or blog site, can provide access to sending private messaging between members (or member followers/friends), whereby an advertising entity can access contact details for sending campaign messages.

By way of example, a socialite entity being a member of an social media avenue that provides private communication between member friends/followers, for example Facebook or LinkedIn, can enable an advertising entity to retrieve contact details of friends/followers and directly send each (or each of a selected subset) a campaign post.

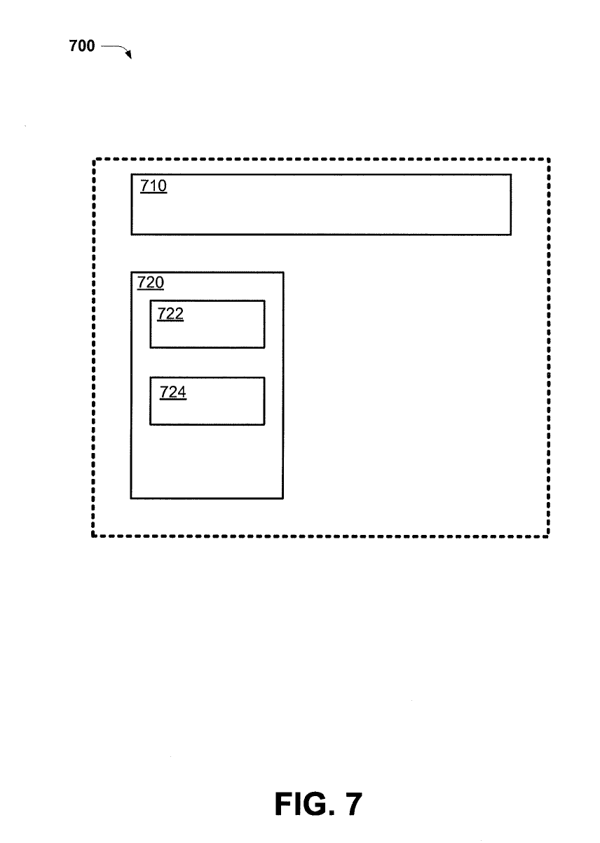

Referring to FIG. 7, a media avenue interface 700 for a member 710 can present one or more messages 720 (for example 722 and 724). The message is associated with a member who posted.

By way of example, for a follower 710 associated with a socialite entity who posted a campaign message, the message may be viewable on the followers message board 720 that includes all messages posted by their friends (including the socialite entity). This means of posting messages is more akin to that employed by Facebook.

Alternatively, a follower can view an interface indicative of the socialite entity 710 having a message board 720 comprising all messages posted by the socialite entity. This means of posting messages is more akin to that employed by Twitter.

Alternatively, a follower can view an email/message interface having a message board 720 comprising all received messages posted by the socialite entity. This means of posting messages is more akin to that employed by email social media avenue or campaigns posted using private messaging between members of a social media avenue.

It will be appreciated that it is beneficial to a campaign entity to confirm effectiveness of a campaign. By identifying performance criteria (including visibility, clicks through, or direct acquisition) associated with a first socialite entity message posting. Historical performance data can be maintained/retained, for example in respect of the socialite entity and/or campaign entity and/or specific campaign.

### Advertising Entity

An embodiment advertising entity can include further controls to ensure that socialite entities and campaign entities achieve a superior benefit. These controls can include any one or more of the following: enforcing minimum bid amounts by campaign entities; maximum number of campaign publications per time period (hour/day/month) by socialite entity.

It will be appreciated that the invention illustrates a method of, or apparatus for, enabling advertising using social media.

In describing the above embodiments, by way of example only, terms used can include the following.
CPF Cost Per Friend/Follower (or Connection etc, and social grouping).
CPC Cost Per Click.
CPA Cost Per Acquisition.
Followers/Friends Used to collectively refer to any of the social media grouping terminology (ie: Facebook friends or Twitter Followers or LinkedIn Connections etc).
Social Media Avenue Relates to any avenue that all social media is available across all technologies (for example, websites, mobile websites, mobile phone apps, tablet apps) across all manufacturers and platforms. Interchangeable with singular and plural.
   Same as: social media website(s) and social media network(s) By way of example only, may include any one or more of the following: Facebook, Twitter, MySpace, Hi5, LinkedIn, Hotmail, Google Mail, Yahoo Mail.
Socialite Entity A user of social media enabling advertising using social media.
Campaign Entity A company, agency or individual who opts to promote their product and/or service through social media avenues.
Advertising Entity Apparatus and method for posing a campaign via a socialite media avenue on behalf of a socialite entity.
Credit Rating A rating allocated to an campaign entity depending on a number of criteria including but not limited to: their real world credit rating from a number of reputable credit agencies, their past reliability in campaigns on social media avenues.
Payment Amount The amount that will be paid to a socialite for publishing the marketing message of the campaign entity.
Marketing Message Refers to any marketing message setup by the campaign entity in a campaign across any number of social media avenues.
Tags A list of keywords defined by the campaign entity when setting up a campaign to give further explanation about what the campaign refers to. Used primarily as a search mechanism.
Pending Payments Amount(s) due to the socialite that is waiting for a number of verification checks prior to actual payment.
Ready For Payment Amount(s) due to the socialite that are ready to be paid but payment has not yet occurred.
Past Payments Amount(s) previously paid to the socialite for publishing the marketing message of their chosen campaign entity.
Publish/Published When a socialite finalizes the process to publish the marketing message of an campaign entity onto the relevant social media avenue.
Verification Timeframe The amount of time that fees to socialites move from pending-payments to ready-for-payment. This is used to ensure that socialites do not publish marketing messages and then immediately delete them. A maximum allowed time can be set.
Payment Cycle The timeframe whereby each socialite is paid. The actual timeframe will depend on what is sustainable and will be determined in advance.
Socialite Method Of Payment An agreed method of payment to the socialite. Examples include: Paypal, Direct Transfer, Credits, Points etc.
Minimum Payment Threshold The minimum amount that must be in the ready for payment account prior to a payment cycle including a payment to a socialite.
Minimum Bid Amount(s) The minimum amount allowed by an campaign entity to offer for their chosen campaign. This can vary depending on advertising method, the category chosen, overall marketing budget etc.
Advertising Method Includes payment in the form of CPF/CPC/CPA.

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein

1. A method for advertising over a computer network using social media, the method comprising:
(a) presenting a campaign interface to a campaign entity for initiating a campaign:
(b) receiving media data indicative of one or more selected social media avenues associated with the campaign;
(c) receiving message data indicative of one or more messages to be associated with each of the selected social media avenues;
(d) receiving, for each selected social media avenue, targeting data indicative of a respective campaign budget and campaign parameters;
(e) initiating the campaign;
(f) receiving payment from the campaign entity;
(g) presenting a socialite interface to a first socialite entity for enabling selection from available campaigns;
(h) receiving campaign selection data indicative of at least a first campaign selected;
(i) presenting available media avenues associated with the first campaign selected;
(j) receiving media selection data indicative of a first media avenue selected from the one or more social media avenues associated with the first campaign selected;
(k) presenting the one or more messages associated with the first media avenue selected;
(l) receiving message selection data indicative of a first message selected from the one or more messages associated with the first media avenue selected; and
(m) posting the first message selected, as a campaign posting on behalf of the first socialite entity, to the first social media avenue selected.

2. The method according to claim 1, further comprising:
(n) validating the campaign posting; and
(o) facilitating payment made to a socialite entity for a validated campaign posting.

3. The method according to claim 1, wherein step (i) through step (m) are repeated for each of the one or more social media avenues associated with the first campaign.

4. The method according to claim 1, wherein the first socialite can repeat steps (i) through (m) for enabling the first socialite to indicate at least a second campaign selection.

5. The method according to claim 1, wherein a second socialite entity can undertake method steps (g) through (m).

6. The method according to claim 1, wherein initiating a campaign involves a transfer of funds to an advertising entity.

7. The method according to claim 1, wherein the campaign budget specifies available payment terms for a prospective socialite entity.

8. The method according to claim 1, wherein the campaign budget specifies any one or more of: Cost Per Friend/Follower (or Connection etc, and social grouping) (CPF), Cost Per Click (CPC) or Cost Per Acquisition (CPA).

9. The method according to claim 1, wherein the campaign parameters can include restrictions imposed, by the campaign entity, on availability of a campaign to a socialite entity.

10. The method according to claim 1, wherein the campaign parameters include any one or more of: maximum allowable overlap, minimum allowable number of friends or followers, maximum allowable number of friends or followers, allowable geographic region, allowable age brackets, allowable languages, allowable date and time to post or publish, allowable date range for campaign, and category (for example retail, lifestyle etc).

11. The method according to claim 1, wherein any socialite entity is presented with only available campaigns.

12. A method for advertising over a computer network using social media, the method comprising:
(i) presenting a campaign interface to a campaign entity for initiating a campaign;
(ii) receiving media data indicative of one or more selected social media avenues associated with the campaign;
(iii) receiving message data indicative of one or more messages to be associated with each of the selected social media avenues;
(iv) receiving, for each selected social media avenue, targeting data indicative of a respective campaign budget and campaign parameters; and
(v) initiating the campaign.

13. The method according to claim 12, wherein payment is received by the advertising entity from the campaign entity.

14. The method according to claim 13, wherein payment is held until completion of the campaign.

15. The method according to claim 14, wherein payment is made at the time the campaign is initiated.

16. The method according to claim 12, wherein each initiated campaign is published to social media.

17. A method for advertising over a computer network using social media, the method comprising:
(i) presenting a socialite interface to a first socialite entity for enabling selection from available campaigns;
(ii) receiving campaign selection data indicative of at least a first campaign selected;
(iii) presenting available media avenues associated with the first campaign selected;
(iv) receiving media selection data indicative of a first media avenue selected from the one or more social media avenues associated with the first campaign selected;
(v) presenting the one or more messages associated with the first media avenue selected;
(vi) receiving message selection data indicative of a first message selected from the one or more messages associated with the first media avenue selected; and
(vii) posting the first message selected, as a campaign posting on behalf of the first socialite entity, to the first social media avenue selected.

18. The method according to claim 17, wherein the campaign posting is validated, and payment can be made to the first socialite entity for a validated campaign posting.

19. (canceled)

20. An apparatus for advertising over a computer network using social media, the apparatus comprising: a processor element coupleable to a database, the database being adapted to retain campaign data; the processor element being adapted to perform a method comprising:
(a) presenting a campaign interface to a campaign entity for initiating a campaign;
(b) receiving media data indicative of one or more selected social media avenues associated with the campaign;
(c) receiving message data indicative of one or more messages to be associated with each of the selected social media avenues;
(d) receiving, for each selected social media avenue, targeting data indicative of a respective campaign budget and campaign parameters;
(e) initiating the campaign;
(f) receiving payment from the campaign entity;
(g) presenting a socialite interface to a first socialite entity for enabling selection from available campaigns;
(h) receiving campaign selection data indicative of at least a first campaign selected;
(i) presenting available media avenues associated with the first campaign selected;
(j) receiving media selection data indicative of a first media avenue selected from the one or more social media avenues associated with the first campaign selected;
(k) presenting the one or more messages associated with the first media avenue selected;
(l) receiving message selection data indicative of a first message selected from the one or more messages associated with the first media avenue selected; and
(m) posting the first message selected, as a campaign posting on behalf of the first socialite entity, to the first social media avenue selected.

21. An apparatus for advertising over a computer network using social media, the apparatus comprising:
a processor element coupleable to a database, the database being adapted to retain campaign data;
the processor element being adapted to present a campaign interface to a campaign entity for receiving campaign data and to initiate the campaign;
the processor element being adapted to present a socialite interface to a socialite entity for enabling campaign selection; and
the processor element being adapted to post one or more campaign messages, on behalf of the socialite, to a social media avenue.

22. The apparatus according to claim 21, wherein campaign data includes any one or more selected from the set comprising: media data, message data, and targeting data.

23. The apparatus according to claim 21, wherein the database further includes a socialite record comprising data indicative of the socialite entity.

24. The apparatus according to claim 23, wherein the socialite record includes data indicative of socialite campaign selection and socialite performance history.

25. The apparatus according to claim 21, wherein the campaign interface or socialite interface is presented through a data communication network.

26. The apparatus according to claim 25, wherein the campaign interface is presented through a web interface.

27. (canceled)

28. An campaign interface on a processor device for advertising over a computer network using social media, the processor device being operatively associated with advertising using social media, the processor device being coupleable to database for retaining campaign data; the interface comprising: a control program adapted to perform a method comprising:
(i) presenting a campaign interface to a campaign entity for initiating a campaign;
(ii) receiving media data indicative of one or more selected social media avenues associated with the campaign;
(iii) receiving message data indicative of one or more messages to be associated with each of the selected social media avenues;
(iv) receiving, for each selected social media avenue, targeting data indicative of a respective campaign budget and campaign parameters; and
(v) initiating the campaign.

29. A socialite interface on a processor device for advertising over a computer network using social media, the processor device being adapted to provide advertising using social media, the processor device being coupleable to database having campaign data; the interface comprising: a control program adapted to perform a method comprising:
(i) presenting a socialite interface to a first socialite entity for enabling selection from available campaigns;
(ii) receiving campaign selection data indicative of at least a first campaign selected;
(iii) presenting available media avenues associated with the first campaign selected;
(iv) receiving media selection data indicative of a first media avenue selected from the one or more social media avenues associated with the first campaign selected;
(v) presenting the one or more messages associated with the first media avenue selected;
(vi) receiving message selection data indicative of a first message selected from the one or more messages associated with the first media avenue selected; and
(vii) posting the first message selected, as a campaign posting on behalf of the first socialite entity, to the first social media avenue selected.

30. A computer program product stored on a computer usable medium, the computer program product adapted to provide a for advertising over a computer network using social media, the method comprising:
(a) presenting a campaign interface to a campaign entity for initiating a campaign;
(b) receiving media data indicative of one or more selected social media avenues associated with the campaign;
(c) receiving message data indicative of one or more messages to be associated with each of the selected social media avenues;
(d) receiving, for each selected social media avenue, targeting data indicative of a respective campaign budget and campaign parameters;
(e) initiating the campaign;
(f) receiving payment from the campaign entity;
(g) presenting a socialite interface to a first socialite entity for enabling selection from available campaigns;
(h) receiving campaign selection data indicative of at least a first campaign selected;
(i) presenting available media avenues associated with the first campaign selected;
(j) receiving media selection data indicative of a first media avenue selected from the one or more social media avenues associated with the first campaign selected;
(k) presenting the one or more messages associated with the first media avenue selected;
(l) receiving message selection data indicative of a first message selected from the one or more messages associated with the first media avenue selected; and
(m) posting the first message selected, as a campaign posting on behalf of the first socialite entity, to the first social media avenue selected.
